(19) United States
(12) Patent Application Publication
(10) Pub. No.: US 2008/0266580 A1
(43) Pub. Date: Oct. 30, 2008

(54) Scaling methods for binary image data

(75) Inventors: Yungran Choi, Webster, NY (US); Peter McCandlish, Rochester, NY (US); Clara Cuciurean-Zapan, Fairport, NY (US); Ramesh Nagarajan, Pittsford, NY (US)

Correspondence Address: PILLSBURY WINTHROP SHAW PITTMAN, LLP;XEROX CORPORATION, P.O. BOX 10500, MCLEAN, VA, 22102, US

(73) Assignee: Xerox Corporation, Stamford, CT (US)

(21) Appl. No.: 11/790,185

(22) Filed: Apr. 24, 2007

(51) Int. Cl. G06F 15/00

(52) U.S. Cl. 358/1.2

(57) ABSTRACT

The embodiments describe calculating and store scaling information based on processing input binary image data. By manipulating data that is received in binary format, the most cost effective method for scaling may be chosen. The input image data is scanned, a resolution (e.g., for display or output) is determined and a scaling method is determined. If the input binary image data needs to be scaled down to a smaller resolution, the binary image data is processed and scaled and then converted to grayscale image data. If the image data must be scaled to a larger resolution, the input binary image data is first converted to grayscale image data before processing using a segmentation tag-based scaling method. The scaled image data may then be output to an output device, such as a display, printer, or image output terminal.

### FIELD

The present application is generally related to systems and methods for scaling binary image data. More specifically, it relates to enhanced methods for scaling image data to increase image quality.

### BACKGROUND

Image data comprises a number of pixels. Each pixel corresponds to a defined location in the image. Image data includes various color or gray levels, which contribute to the intensity of each pixel in the image. Each pixel of the image is assigned a number representing the amount of light or gray level for that space at that particular spot; i.e., the shade of gray in the pixel. Binary image data has two possible values for each pixel, black (represented by the number “1”) or white (represented by the number “0”). Images that have a large range of shades of grays are referred to as grayscale images. For example, an 8-bit value comprises 256 values or shades of gray for each pixel in the image. Grayscale image data may also be referred to as continuous tone images or contone images.

When image data is provided by a device, such as a scanner, it is provided in a specific size and/or resolution (e.g., 600×600). The image data often goes through a scaling process to change the size of the image—i.e., by changing the number of pixels of image data. Image data may be scaled up—increasing the size of the image data—or scaled down—reducing the size of the image data. Scaling (up or down) is performed for various purposes, such as: reducing the amount of data, decreasing the output file size, converting the resolution to match the requirements for output resolution, or for the purpose of performing a number of image operations, such as middle function operations (e.g., merge, annotate, signature, etc.). For example, to send an image to an image output terminal (IOT), such as a multifunction product (MFP) (e.g., a solid ink printing device), it may be desirable to scale and rotate the image (e.g., because of the paper orientation or finisher). In order to print image data with dimensions specific to a printer device, the input image data must be scaled to a resolution (e.g., dots per square inch (dpi)) to determine the number of pixels (or dots) that will be distributed in each section of the paper. For example, an input image may be scanned at a resolution of 600×600 dpi (dots per inch), processed using a number of middle function operations, and then rotated and scaled down from 600×600 to 467×375 for output to a printer. The scaling and/or resolution conversion operation(s) should be done without sacrificing image quality.

Some known methods for scaling (up or down) image data down accomplish conversion and reduction by storing and processing grayscale image data. That is, input binary image data is converted to grayscale image data for further processing (e.g., operations such as using a scaling factor on the pixels of image data). Because a large memory is required for storing scanned grayscale data, the above method of processing such can be costly.

When the image data is scaled, however, the resulting image may appear grainier than desirable and may also contain other aliasing artifacts or moiré patterns. This appears especially true in images of relatively small amounts of image data that require a small amount of scaling, such as scaling the image data from 600×600 to 450×500. Thus, the output image quality is lowered. This problem becomes more difficult, for example, when dealing with marking engines that utilize asymmetric resolutions. With asymmetric resolutions, such as 450×500, one cannot decide on the paper tray (long-edge feed or short-edge feed) after scanning the image into memory. This feature is often referred to as “late binding” of a paper tray, which is quite useful feature in MFPs. In order to accomplish this, however, the system requires a quality approach to scaling/rotating binary image data that is stored in the memory. Alternatively, in order to prevent the loss of quality in the image data that is output to MFPs, one method, for example, disables the late binding of paper tray. However, disabling the late binding of the paper tray is inconvenient for a user.

Some methods accomplish image data magnification (i.e., scaling up) by performing pseudo gray remapping or converting the binary image data (1 bit per pixel) to grayscale or contone image data (8 bits per pixel) before scaling. Averaging or linear interpolation scaling algorithms may then be applied to the grayscale or contone image data. In order to convert the image data back to binary, the resulting data may be error diffused, for example. U.S. Pat. Nos. 5,805,304, 6,363,177 and 6,717,770 provide examples of such methods, and are hereby incorporated by reference in their entirety. However, conversion to pseudo gray by remapping may produce a grainy output, and scaling grayscale or contone image data tends to be expensive. Therefore, an approach that improves a resulting image for output devices, such as solid ink based MFP products, is needed.

### SUMMARY

One embodiment provides a method for scaling image data to a resolution comprising: receiving binary image data, the image data comprising a resolution including a plurality of pixels, determining a scaling factor to render the resolution of the received image data to a second resolution, processing the plurality of pixels using a slow scan factor to identify a number of pixels meeting a predetermined criteria, processing the plurality of pixels using a fast scan factor to identify a number of pixels meeting a predetermined criteria, summing the number of pixels identified in both of the processes using the slow and fast scan factors, converting the identified pixels of binary image data into grayscale image data comprising a plurality of pixels; and applying the scaling factor to the pixels of grayscale image data, wherein the grayscale image data is rendered to the second resolution.

In one embodiment the method may further comprise sending the grayscale image data to an output device. In another embodiment, the scaling factor is determined by calculating a ratio of a number of pixels to be sent to the output device as compared to the plurality of pixels of binary image data that are received.

Another embodiment provides a method for scaling image data to a target resolution comprising: receiving binary image data, the binary image data comprising a resolution including a plurality of pixels; converting the binary image data into grayscale image data, the grayscale image data comprising a plurality of pixels; inserting at least one tag in the grayscale image data, the at least one tag identifying pixels to be rendered for the target resolution; rendering the identified pixels of grayscale image data, and sending the rendered grayscale image data to an output device.

In an embodiment, the at least one tag identifies a scaling method to be applied to the identified pixels of grayscale image data. In an embodiment, the scaling method includes at least one selected from the group consisting of: remapping, linear interpolation, nearest neighbor, and cubic interpolation. In another embodiment, the conversion of binary image data to grayscale image data includes at least one selected from the group consisting of remapping, pseudo gray conversion, tag-based algorithms, or template matching and filtering.

Yet another embodiment provides a system for scaling image data comprising an input device for receiving image data, the image data comprising a resolution including a plurality of pixels, an image conversion module inserting at least one tag in the image data, the at least one tag identifying pixels to be scaled to a second resolution; a processor for scaling the identified pixels of image data to the second resolution, and an output device for outputting the scaled image data.

The at least one tag may identifies a scaling method to be applied to the identified pixels of image data in an embodiment. In one embodiment, the input device receives binary image data, and the processor converts the binary image data to grayscale image data before the conversion module inserts the at least one tag in the image data.

In an embodiment, the output device is a xerographic printer, an inkjet printer, a solid-ink jet printer, or a display.

Other objects, features, and advantages of the present invention will become apparent from the following detailed description, the accompanying drawings, and the appended claims.

### BRIEF DESCRIPTION OF THE DRAWINGS

FIG. 1 is a method for scaling using binary image data according to an embodiment.

FIG. 2 is a method for scaling down binary image data according to an embodiment.

FIG. 3 is a method for scaling up binary image data for output according to an embodiment.

FIG. 4 illustrates a system that may be used for scaling according to an embodiment.

### DETAILED DESCRIPTION OF THE ILLUSTRATED EMBODIMENT(S)

The methods described herein are methods of spatially scaling images or image data to change the size of the image, i.e., by changing the number of pixels of image data. In an embodiment, binary data is input, and, based on the method (e.g., scaling up or scaling down) used to manipulate the image size (i.e., increase or decrease the size of the image), the data is processed using methods that are designed to be more cost effective while still maintaining superior image quality.

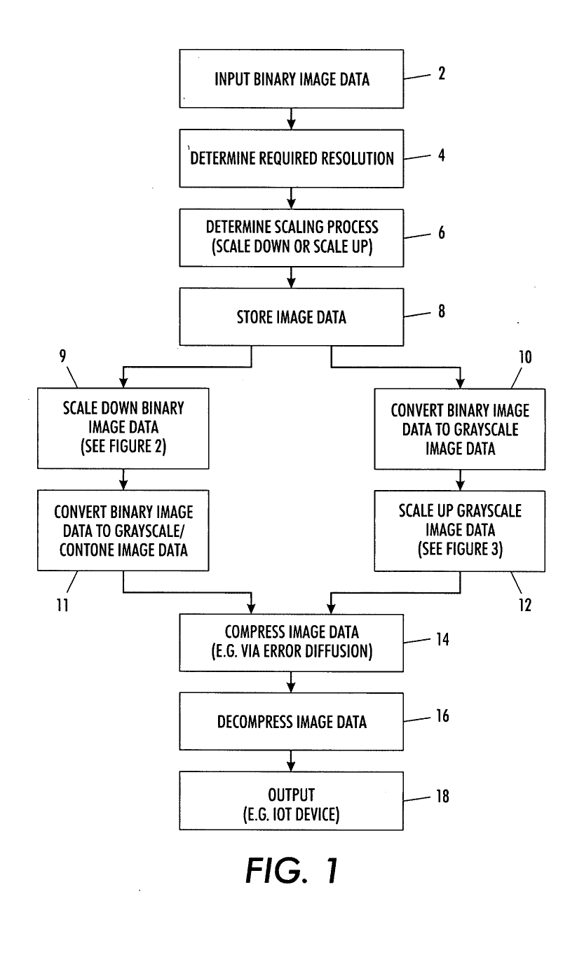

In particular, the methods herein describe calculating and store scaling information based on processing input binary image data. By manipulating data that is received in binary format, the most cost effective method for scaling may be chosen. FIG. 1 illustrates a method for scaling using binary image data according to an embodiment. As shown, binary image data is input 2 at a resolution. The input image data is scanned, and the required resolution (e.g., for display or output) is determined 4. Once the required resolution is determined 4, the scaling process for the input image data is determined 6. For example, steps 4 and 6 may be used to determine a ratio of the number of pixels of image data that may need to be output as compared to the number of pixels of binary image data. From such a comparison, a scaling factor and/or a scaling method (e.g., scale down or scale up) may be determined.

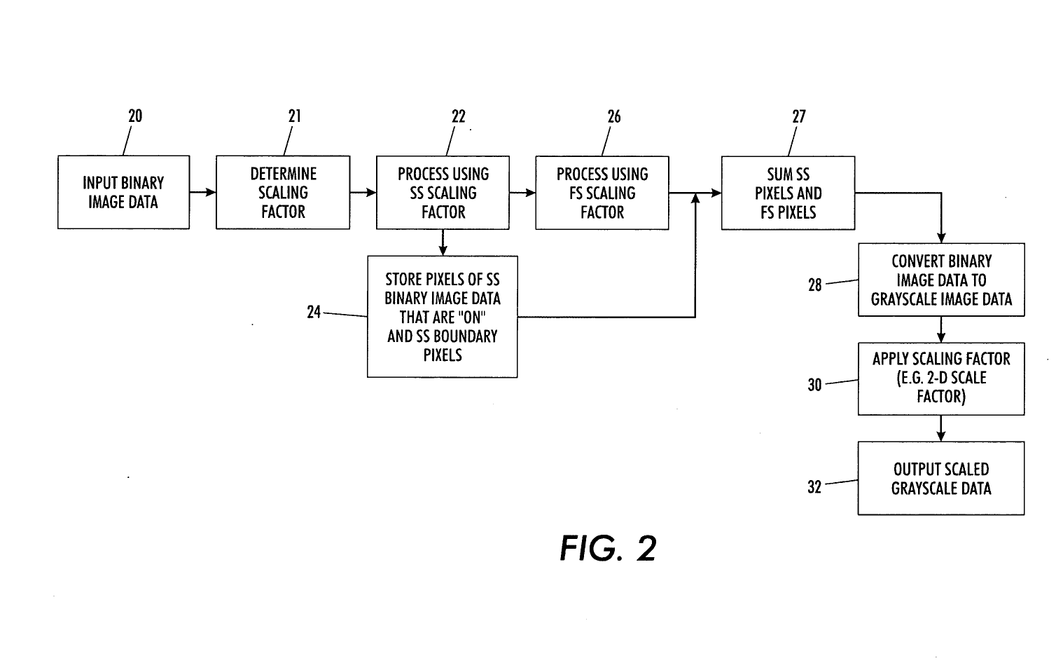

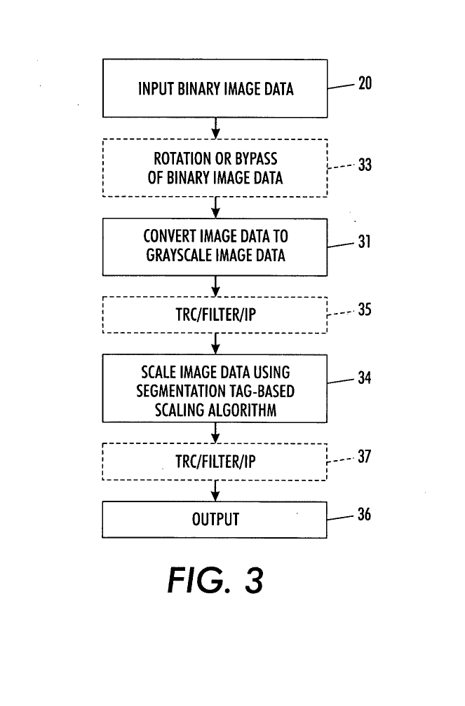

The image data is then stored 8. If the input binary image data needs to be scaled down to a smaller resolution, the binary image data is scaled down 9, such as by the method as described in the embodiment of FIG. 2, and then converted to grayscale or contone image data 11. If the image data must be scaled up to a larger resolution, the input binary image data is first converted to grayscale image data 10. The grayscale image data may then be scaled up 12, such as by the method as described in the embodiment of FIG. 3. Both methods, whether scaled down or scaled up, result in scaled grayscale or contone image data. The grayscale image data is then compressed 14 (e.g., by known processes such as error diffusion) and stored, and then decompressed 16 for output. The image data may then be output 18 to an output device, such as a display, printer, or image output terminal (IOT).

FIG. 2 is a method for scaling down binary image data according to an embodiment. As shown, binary data is input 20. The binary data comprises a resolution including a plurality of pixels. The pixels of the binary data are scanned, and a scaling factor 21 is determined. For example, the number of pixels that are scanned may be compared to the number of pixels to be output (e.g., to an output device such as a printer or display). This ratio—of the number of pixels to be sent as output as compared to the number of pixels that are scanned from the input binary image data—may be used to determine the scaling factor for scaling the image data to a second resolution.

The pixels are then processed in order to reduce the image data from its original resolution to the second resolution. In an embodiment, as shown in FIG. 2, the pixels of binary data may be scanned using a process that slow-scans (SS) the pixels using a slow scan (SS) factor in one direction and fast-scans (FS) the pixels using a fast scan (FS) factor in a perpendicular direction. The pixels are processed in the slow-scan direction and a SS scaling factor is applied 22. The slow scan identifies a number of binary pixels for storing within a memory 24, such as a number of binary pixels that are “on” within the scale factor window (i.e., the number of pixels that have a value of “1”) and the number of boundary pixels. The pixels of binary image data are then processed in the fast-scan direction and a FS scaling factor is applied 26 to also identify a number of pixels within the window, such as pixels that are “on” in the fast scan direction or the number of boundary pixels. The sums of the identified SS pixels that are stored in the memory 24 are then summed 27 with the identified FS pixels.

The above method or process described with respect to steps 22-27 may also be referred to as “N-scaling”. An example of an N-scale method and an implementation approach is provided in U.S. Pat. No. 6,424,751 B2, which is hereby incorporated by reference in its entirety. For example, this reference describes a process that assumes input image data is in grayscale (8 bits per pixel), and the processing is performed on 8-bit data that requires a lot of memory.

After processing and calculating the sums of the binary image data, the sums of identified pixels are converted to grayscale image data 28. The grayscale image data comprises a plurality of pixels. The grayscale image data is then scaled 30 by applying the scaling factor (e.g., using a 2-D scale factor) that was previously determined to scale the grayscale image data to the second resolution. The scaling factor may be applied, for example, using a division operation. The scaled image data may then be output 32. The image data may be output to an output device such as an image output terminal (IOT), for example, a MFP, xerographic printer, inkjet printer, solid ink printing device, or display.

The above described method calculates and stores scaling information based on processing binary image data. A large memory may be required in order to store a scanned line(s) of grayscale data. Instead of converting binary data to grayscale data prior to applying the slow scan or fast scan factors, the number of “on” binary pixels in the method of FIG. 2 are counted and stored until a final calculation is needed. Because the slow and fast scan factors are applied to the binary image data, and the binary pixel data (i.e., 1-bit) is stored in the memory instead of summed grayscale data (e.g., 8-bits), the described method provides a method for scaling or re-sizing the resolution of an image that may be performed at lower cost. Additionally, by manipulating the data in binary format, transfer rates are quicker than when using grayscale image data.

Although FIG. 2 provides scaling of image data within an input device, in one embodiment the scaling down function may be performed in the output device rather than the input device. Alternatively, in another embodiment, the method of FIG. 2 may be applied to any legacy binary system where high-quality scanning may be required.

In another embodiment, in order to change the size of image data to a target resolution, a tag-based method, as shown in FIG. 3, is provided. FIG. 3 shows an embodiment of a method for binary to gray conversion and tag based scaling algorithms, which helps in further improving the image quality of the scaled output. As shown, binary image data comprising a resolution including a plurality of pixels is input 20 (e.g., such as video image data) and a scaling factor is determined, as previously described with respect to FIGS. 1 and 2. The binary image data is then converted to grayscale image data 31 using known techniques such as remapping, pseudo gray conversion, tag-based algorithms, template matching, or filtering. U.S. Pat. Nos. 5,553,171, 6,343,159, 6,363,177, 6,678,414, 6,717,700, and 6,757,431 as well as U.S. Patent Application Publication 2006/0257045 disclose examples of such methods for binary to gray conversion, and are hereby incorporated by reference in their entirety.

After the binary image data undergoes conversion to become grayscale image data, a segmentation tag-based scaling algorithm is performed 34 using the grayscale image data. The grayscale image data comprises a plurality of pixels that may be tagged for scaling. Specifically, at least one tag corresponds to each pixel to be processed to obtain the target resolution of the image data. For each pixel, the tag indicates what scaling method shall be used for the given pixel. Examples of scaling methods that may be used include, but should not be limited to: remapping, linear interpolation, nearest neighbor, or cubic interpolation algorithms. After the pixels are processed and at least one tag is utilized to scale the grayscale image data, the scaled grayscale data may then be output 36 to an output device. The output device may be used to convert the scaled grayscale data to halftone image data for printing or displaying. Any method may be used to convert the grayscale data to halftone image data. The output device may comprise an image output terminal (IOT), for example, a MFP, xerographic, inkjet, or solid ink printing device, or a display

The above described method calculates and stores scaling information based on tagging and processing grayscale image data. The application of the segmentation tag-based scaling algorithm to the grayscale image data enhances the image quality in the resulting scaled image over scaled binary images that tend to appear grainy or contain other artifacts. Also, the method remains at low cost in that converting binary image data to grayscale image data may be implemented using cost-effective methods such as a simple lookup table or other known conversion methods.

The method of FIG. 3 also provides an advantage in that it helps provide the late binding features for paper tray selection that are found in MFPs without sacrificing the image quality of the output.

In one embodiment, the binary image data may need to be rotated for the designated output device. For example, the image data may need to be rotated when using a solid ink jet printer device of a specified resolution. Thus, the method of FIG. 3 may optionally perform rotation or bypass of the binary data 33 before the binary to grayscale conversion 31.

Also, in one embodiment, the image data may be further processed using known image processing (IP) techniques either before 35 or after scaling 37 the image data. For example, in an embodiment, the image data may be filtered. Filtering the image data may be used to enhance the quality of the output image or to minimize moiré and/or aliasing artifacts that may result from scaling.

In another embodiment, the grayscale image data may be processed using tone reproduction curves (TRC) to further enhance the image or provide the user with additional controls to modify the image. In one embodiment, if there is tag data available, it may be beneficial to apply different TRCs/filters to text line edges and images.

Although filtering and TRC are provided as techniques for further enhancing the image, other known image processing (IP) techniques may also be used in optional steps 35 and 37.

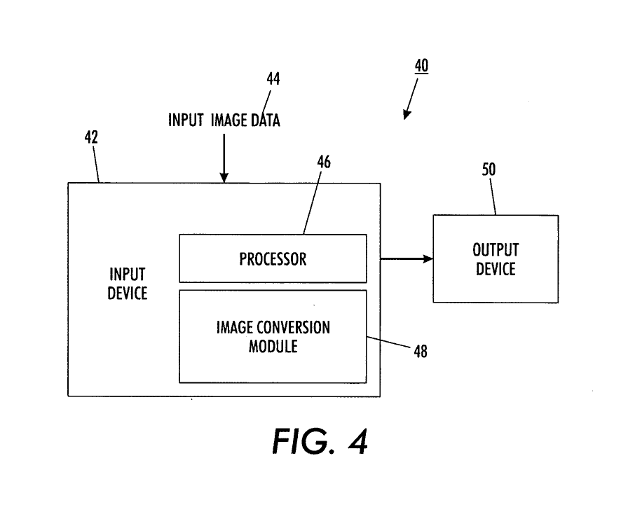

FIG. 4 illustrates a system that may be used for scaling in one embodiment. The system 40 comprises an input device 42 for receiving input image data 44. In an embodiment, the image data 44 is binary image data comprising a plurality of pixels. The image data 44 is analyzed by the image conversion module 48. Image conversion module 48 inserts at least one tag per each pixel of the image data. The tag identifies the scaling method to be used for each pixel. A processor 46 is used for scaling the identified or “tagged” pixels of image data. Once scaled, the image data may be sent to an output device 50. The output device 50 may be a multifunction, inkjet, or solid-ink jet printer, or a display, for example.

In one embodiment, the input device 42 receives binary image data 40. The processor 46 then converts the binary image data 40 to grayscale image data before allowing the image conversion module to insert a tag in the image data.

In one embodiment, the tag is used to identify a scaling method to be applied to the pixels of image data.

Also, in an embodiment, the binary image data may be converted into grayscale image data before scaling the image data.

In another embodiment, the processor 46 may be used to convert image data that has been scaled to halftone image data, such as for output to the output device 50.

While the principles of the application have been made clear in the illustrative embodiments set forth above, it will be apparent to those skilled in the art that various modifications may be made to the structure, arrangement, proportion, elements, materials, and components used in the practice of the application.

It will thus be seen that the objects of this application have been fully and effectively accomplished. It will be realized, however, that the foregoing preferred specific embodiments have been shown and described for the purpose of illustrating the functional and structural principles of this application and are subject to change without departure from such principles. Therefore, this application includes all modifications encompassed within the spirit and scope of the following claims.

What is claimed is:

1. A method for scaling image data to a resolution comprising:
receiving binary image data, the image data comprising a resolution including a plurality of pixels,
determining a scaling factor to render the resolution of the received image data to a second resolution,
processing the plurality of pixels using a slow scan factor to identify a number of pixels meeting a predetermined criteria,
processing the plurality of pixels using a fast scan factor to identify a number of pixels meeting a predetermined criteria,
summing the number of pixels identified in both of the processes using the slow and fast scan factors,
converting the identified pixels of binary image data into grayscale image data comprising a plurality of pixels; and
applying the scaling factor to the pixels of grayscale image data,
wherein the grayscale image data is rendered to the second resolution.

2. A method for scaling image data according to claim 1, further comprising sending the grayscale image data to an output device.

3. A method for scaling image data according to claim 2, wherein the scaling factor is determined by calculating a ratio of a number of pixels to be sent to the output device as compared to the plurality of pixels of binary image data that are received.

4. A method for scaling image data according to claim 2, wherein the output device is a multifunction xerographic printer, an inkjet printer, or a solid-ink jet printer, or a display.

5. A method for scaling image data to a target resolution comprising:
receiving binary image data, the binary image data comprising a resolution including a plurality of pixels;
converting the binary image data into grayscale image data, the grayscale image data comprising a plurality of pixels;
inserting at least one tag in the grayscale image data, the at least one tag identifying pixels to be rendered for the target resolution;
rendering the identified pixels of grayscale image data, and
sending the rendered grayscale image data to an output device.

6. A method for scaling image data according to claim 5, wherein the at least one tag identifies a scaling method to be applied to the identified pixels of grayscale image data.

7. A method for scaling image data according to claim 6, wherein the scaling method includes at least one selected from the group consisting of: remapping, linear interpolation, nearest neighbor, and cubic interpolation.

8. A method for scaling image data according to claim 5, wherein the conversion of binary image data to grayscale image data includes at least one selected from the group consisting of remapping, pseudo gray conversion, tag-based algorithms, or template matching and filtering.

9. A method for scaling image data according to claim 5, wherein the output device is a xerographic printer, an inkjet printer, a solid-ink jet printer, or a display.

10. A system for scaling image data comprising:
an input device for receiving image data, the image data comprising a resolution including a plurality of pixels,
an image conversion module inserting at least one tag in the image data, the at least one tag identifying pixels to be scaled to a second resolution;
a processor for scaling the identified pixels of image data to the second resolution, and
an output device for outputting the scaled image data.

11. A system according to claim 10, wherein the at least one tag identifies a scaling method to be applied to the identified pixels of image data.

12. A system according to claim 10, wherein the input device receives binary image data, and the processor converts the binary image data to grayscale image data before the conversion module inserts the at least one tag in the image data.

13. A system according to claim 10, wherein the output device is a xerographic printer, an inkjet printer, a solid-ink jet printer, or a display.
